(19) United States
(12) Patent Application Publication
(10) Pub. No.: US 2018/0116031 A1
(43) Pub. Date: Apr. 26, 2018

(54) METHOD AND APPARATUS FOR CONTROLLING SPACE ILLUMINATION

(71) Applicants: Peter Braunschmid, Aalen (DE); Stefan Raithel, Rudersberg-Schlechtbach (DE); Andreas Schelling, Waiblingen (DE)

(72) Inventors: Peter Braunschmid, Aalen (DE); Stefan Raithel, Rudersberg-Schlechtbach (DE); Andreas Schelling, Waiblingen (DE)

(21) Appl. No.: 15/791,733

(22) Filed: Oct. 24, 2017

(30) Foreign Application Priority Data
Oct. 25, 2016 (DE) 10 2016 120323.8

(51) Int. Cl. H05B 37/02

(52) U.S. Cl. CPC H05B 37/0218; H05B 37/0245; H05B 37/0227

(57) ABSTRACT

A sensor-controlled illumination apparatus is provided whose response to light is basically made at a small time constant. This is applicable both when brightening illumination and when darkening the illumination. However, in the case of the darkening, a darkening speed is limited when a decrease in luminance per unit time exceeds a limit value. The above-described method makes it easy to successfully adapt the illumination to given necessity on one hand, and on the other hand, allows people in an illuminated area to feel less uncomfortable with the sequential adjustment of the illumination, or in an ideal case, to be unaware of the adjustment.

### CROSS-REFERENCES TO RELATED APPLICATIONS

This application claims benefit of German Patent Application No. 10 2016 120323.8, filed Oct. 25, 2016, and which is hereby incorporated by reference.

### BACKGROUND

The present invention relates to an apparatus for controlling space illumination using one or more light sources, and to a method for controlling light.

When illuminating a living space or a working space using variable luminance, i.e., using a dimming controllable light source, by measuring space illumination intensity several times, space illumination is made to function in accordance with the degree of necessity, or excessively bright illumination as well as insufficient illumination is avoided. For example, in a space using natural illumination through a window, illumination intensity observed at a measurement location is that of the synthesis of natural light and artificial light from a controlled light source. The incidence of the natural light varies both in a short time and in a long time a day, and the electric light source for the space illumination must be correspondingly adjusted.

For this purpose, EP2955979A2 separates between short- and long-term variations in light incident on a light sensor, and thereby in response to a short-term variation in daylight, which may be caused by a small cloud, avoids a change in brightness. A short-term difference appearing between ideal illumination intensity and actual illumination intensity in a working area is accepted.

The same is applicable to another phenomenon of becoming bright or dark in a short time, and the phenomena may be caused by, for example, a flash of a camera, or a flock of birds flying across the sun.

WO2014/018234A1 discloses a somewhat different approach. In the approach, the difference between current illumination and ideal illumination is measured by a sensor, and an increase in illumination is immediately provided, whereas a decrease in illumination is started for the first time after a stabilization time has passed. The stabilization time may be fixed, or fixed in the course of events. Accordingly, oscillation, or a repetition of increase and decrease in space illumination is avoided.

What is basically required is illumination always corresponding to the degree of necessity in a living space or a working space, and in an ideal case, artificial space illumination adapts to a change in the luminance of incident natural light without awareness. In such a case, people in the illuminated space recognize the light depending not only on illumination intensity but also on the incident direction of the light. The existing systems hardly take account of this.

### BRIEF SUMMARY

The problem of the present invention is to provide an improved concept on light recognition for space illumination.

The problem can be solved by an apparatus and a method as claimed herein.

The apparatus for space illumination according to the present invention includes a control circuit for determining illumination intensity at at least one selected location in a space to be illuminated, and the control circuit controls a controllable drive circuit with use of illumination intensity detected by a sensor. The control circuit is configured to start or be able to start at least one drive circuit so as to increase or decrease the drive current of a light source (or multiple light sources). The drive current is decreased in proportion to a difference detected between predetermined illumination intensity and actual illumination intensity, as in a necessary increase case. However, when a decrease in the illumination intensity per unit time exceeds a constant value, a decrease in the illumination intensity, i.e., the change speed or rate of a decrease in the drive current is limited. The control circuit may decrease the drive current at a first high rate, e.g., at (Lₛₒₗₗ−L)/a, for example, when a previous decrease does not exceed a limit value. On the other hand, when the previous decrease reaches or exceeds the limit value, the control circuit may decrease the drive current at a smaller rate, e.g., at (Lₛₒₗₗ−L)/a_{g}.

In doing so, a relatively small increase or decrease in the illumination intensity can be quickly provided, and in most cases, people around are hardly aware of such a small change in the illumination intensity and therefore do not feel uncomfortable. On the other hand, a necessary increase in the illumination intensity due to, for example, the darkening of the sun caused by a cloud or due to closing a shutter is provided at a necessary brightening speed of the prepared light source without any problem. Also, a very rapidly darkening phenomenon appearing when closing the slats of a blind is immediately responded to by in fact correspondingly increasing space illumination. On the other hand, the illumination is darkened in at least a suppressed state. When the closed slats of a blind is opened and daylight suddenly enters the space filled with the artificial light, the control circuit attempts to rapidly darken the space illumination preferably by an amount that people around are unaware of without consciousness or makes the people feel as comfortable as possible. In addition, by limiting the first rapid darkening to this extent, an each measurement error of the luminance sensor, sudden light reflection, or an equivalent event can be prevented from leading to an excessive response. When the first darkening corresponding to excessive light caused by the sudden incident daylight is not sufficient, a necessary remaining decrease in the drive current of the light source is gradually provided over a time interval of several tens of seconds or in some cases, a time interval of minutes.

The nature of the present invention appears in particular when a large amount of darkening is performed or darkening is very frequently performed over a long time as compared with a time out of control. In addition, the darkening is intentionally delayed.

It is advantageous that the amount of the first darkening is extremely small, and sudden incident daylight generally coming from a direction different from that of artificial light does not blind user's eyes. The artificial light illumination in a working area is kept and decreased only moderately such that a user have a time to get used to the situation of the other light incident.

Such an illumination concept allows a variation in luminance, which is uncomfortable as space illumination, to be avoided as with continuous insufficient illumination, and consequently, excessive power consumption or insufficient illumination intensity in a working area or a living area can also be avoided.

The drive current may be decreased stepwise, and the level difference between adjacent steps may be constant or proportional to the difference between desired illumination intensity and the illumination intensity detected by the sensor. This is applicable at least when a decrease in the illumination intensity is moderately provided, i.e., when the speed of the decrease in the illumination intensity does not reach a limit value. On the other hand, when the speed reaches the limit value, the illumination intensity is further decreased by an amount equal to a limited level difference, and in doing so, a rapid decrease in the lamp luminance is avoided from being impressively conspicuous.

Instead of decreasing the drive current and therefore decreasing the illumination intensity stepwise, the decrease is also smoothly provided. In this case as well, immediately after a significant decrease in the luminance has reached a limit value in a previous time interval, the speed of the decrease in the luminance is limited.

Independently of the smooth or stepwise decrease in the luminance, the decrease in the luminance actually takes account of previous progress. When the decrease in the luminance has already been provided in a previous time interval, and reached the limit value, the speed of the decrease in the luminance to be actually provided is limited to a previous speed. However, when the decrease in the luminance does not reach the limit value in the previous time interval, the decrease in the luminance to be provided may be provided at a high change speed, for example, at the same change speed as that of brightening.

The purpose of including the control circuit is to, when the illumination intensity is too high, temporarily allow a control difference that is large as compared with when the illumination intensity is too low. Accordingly, insufficient illumination in a working area can be surely eliminated, and on the other hand, people's uncomfortable feeling due to space illumination whose luminance constantly changes, or the effect of the space illumination can be avoided.

The concept of the present invention is not to focus on keeping illumination intensity in an area to be illuminated constant but to improve illumination quality for physiological advantageousness. An observer rapidly gets used to a rapid increase in luminance, but needs time to get used to a decrease in illumination intensity. The concept of the present invention takes account of this. In addition, when ambient brightness increases, it may be advantageous to keep the sum of illumination intensity due to natural light and illumination intensity due to artificial light slightly more than a predetermined value over a constant time interval (e.g., 20 seconds to several minutes). The time interval may be determined in particular such that a short time variation in natural light illumination due to, for example, a cloud covering a fair sky does not lead to a noticeable decrease in artificial light illumination.

The method according to the present invention is used in order to control light in a space illuminated with use of at least one electrical light source, in which a control circuit is used to determine the drive current of the light source. By using at least one sensor, illumination intensity at a selected location in the space is detected, and the drive current corresponding to the illumination intensity detected by the sensor is determined. The drive current is increased or decreased so as to correspond to the illumination intensity detected by the sensor. At this time, when an accumulated decrease in the illumination intensity during a previous time intervals during which darkening has occurred once or multiple times does not exceed a limit value, the drive current is decreased at a first high rate. On the other hand, when the accumulated decrease in the illumination intensity during the previous time interval reaches or exceeds the limit value, the drive current is decreased at a low rate.

In particular, the accumulated decrease in the illumination intensity can be detected with use of a step counter, and the step counter is incremented in relation to a provided decrease in the illumination intensity, i.e., incremented by one or more.

The accumulated decrease in the illumination intensity detected with use of the step counter can be continuously accumulated by decreasing the step counter stepwise at predetermined timing (by decrementing the step counter by one or more). The timing may be given by the passing of a program loop, and the step counter is decremented by one every time the passing occurs.

### BRIEF DESCRIPTION OF THE SEVERAL VIEWS OF THE DRAWINGS

Further details of advantageous embodiments can be obtained from the drawings, specification, and claims, in which:

FIG. 1 is a schematic diagram of a space provided with illumination apparatuses according to the present invention;

FIG. 2 illustrates the illumination apparatuses of FIG. 1 in an embodiment exemplified by an abstract block illustration;

FIG. 3 is a flowchart representing the operation of a control circuit for implementing the method according to the present invention; and

FIGS. 4 to 13 are graphs showing functions of embodiments of the apparatus and method according to the present invention.

### DETAILED DESCRIPTION

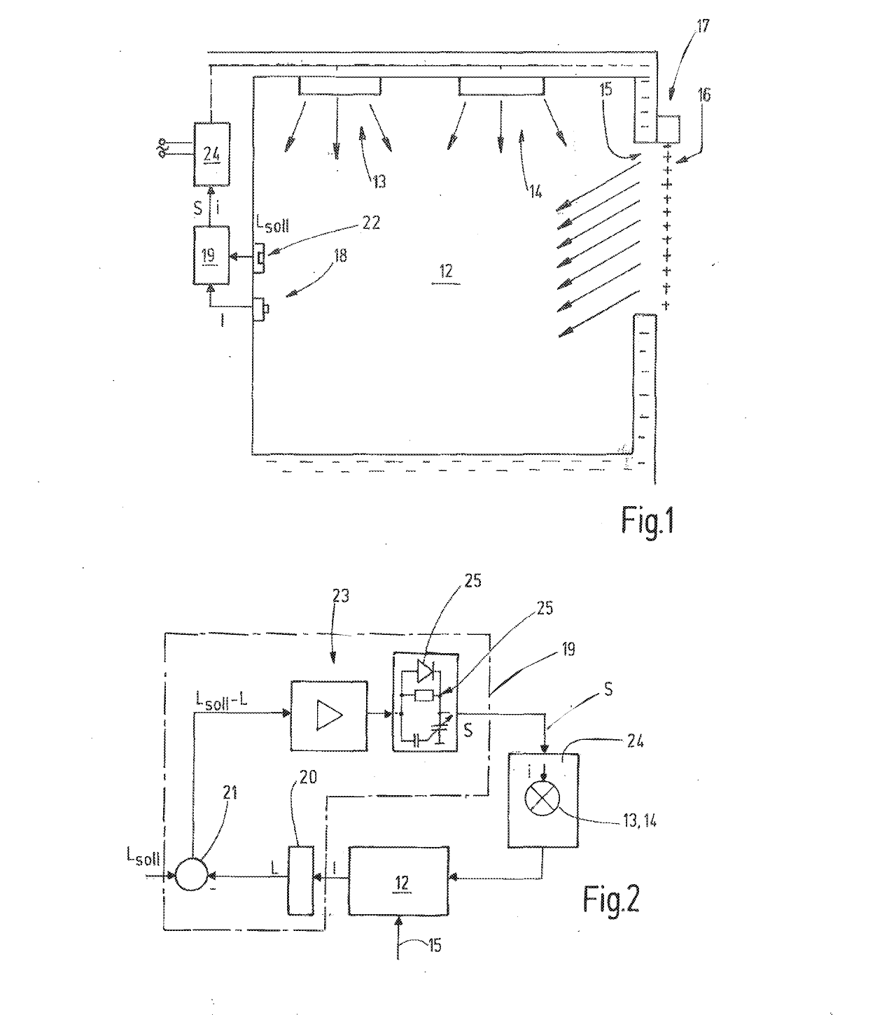

FIG. 1 schematically illustrates a space 12, and the space is illuminated using electrically driven light sources 13, 14. In addition, the space 12 takes in daylight having variable intensity through at least one window 15 or an opening part located in another place. In a long-term sense, the variation in the intensity is determined by a change in natural light illumination during the day time, i.e., by the position of the sun; in a medium-term sense, may be determined by the effect of weather conditions such as the presence or absence of cloud; and in a short-term sense, may be determined in seconds by opening/closing slats 16 of a blind 17. The blind 17 or another device provided for shading can also darken or brighten the space in a long-term sense.

One or more sensors 18 are provided in order to detect illumination intensities at at least selected locations in the space 12, and the sensors receive both natural light coming through the window 15 and artificial light coming from the light sources 13, 14, and transmit signals l indicating the illumination intensities at the locations of the sensors 18. The signals l are transmitted to a control circuit 18 whose internal structure is illustrated in the embodiment of FIG. 2.

The structure of the control circuit 19 is, for example, as follows.

The control circuit 19 includes a sensor signal input part, and an optionally provided average value calculation block 20 is connected to the sensor signal input part. For example, the average value calculation block 20 is configured to include a calculation circuit, low-pass filter, and integrator, or in a similar form. The average value calculation block 20 calculates a current average value of the signals l, and transmits the average value to the next block as a smoothed signal L. Note that the average value calculation block 20 may be omitted in any embodiment, and is therefore optional. The function of the average value calculation block 20 may be carried by the sensors 18, and therefore the sensors may calculate the current average to thereby average the detected illumination intensities, and transmit the signal L resulting from the averaging for illumination to the control circuit 19. Alternatively, the average value calculation may be omitted.

The signals l or the signal L is transmitted to a comparator block 21. The comparator block 21 compares the current illumination intensity with desired illumination intensity Lsoll that can be determined using, for example an input device 22. The input device 22 may be formed in a wired or wireless transmission section using a rotary potentiometer, a keyboard, and a touch screen, to which for example, a mobile terminal device (e.g., a smart phone), a computer, or a similar device is connected, and determines a predetermined value of the desired illumination intensity to transmit it to the control circuit 19.

The comparator block 21 calculates the difference between the desired illumination intensity Lsoll and the actual illumination intensity L, and transmits the difference to a control amplifier 23. When the actual illumination intensity L is smaller than the predetermined illumination intensity Lsoll, the control amplifier 23 directly transmits a signal S obtained by amplifying the difference by an amplification factor to a drive circuit 24 for controlling the light sources 13, 14. This is basically done without any delay as indicated by a diode 25 symbol in FIG. 2. Accordingly, when daylight incidence is insufficient, the insufficiency is immediately compensated for by brightening the light sources 13, 14. For example, when an operator closes the slats 16 of the blind, the light emitted from the light sources 13, 14 are immediately brightened.

The signal S corresponds to, for example, the number of a luminance steps, and the illumination is brightened or darkened by the number. The signal S corresponding to the number of steps may be a dimming control signal corresponding to the number of steps in a defined bus transmission protocol, for example, in the DALI protocol. The number of steps is applied in order to both brighten and darken the illumination.

On the other hand, when darkening the illumination, the signal transmitted from the control amplifier 23 must pass through the low-pass filter 25 having a variable time constant. In FIG. 2, this is indicated simply by a variable capacitor symbol, and the value of it is changed in relation to a signal change speed and/or a signal change amount. When the signal change speed or the signal change amount required is large, by setting the time constant of the low-pass 25 to a large value, the drive current i of the light sources 13, 14 gradually decreases, i.e., the signal S gradually decreases. When the signal change speed or the signal change amount expected is small, by setting the time constant of the low-pass 25 to a small value, the drive current i of the light sources 13, 14 gradually increases, i.e., the signal S gradually increases.

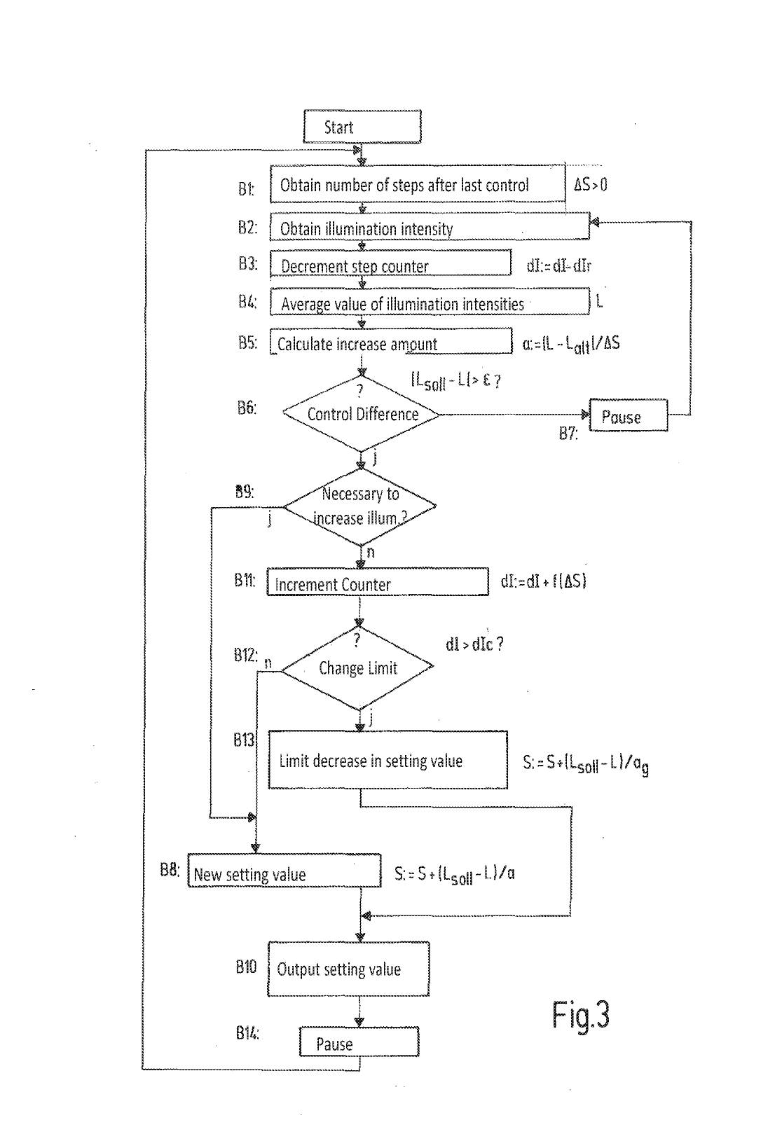

The embodiment of FIG. 2 is used only for clearly describing the functions of the control circuit 19 on a principle basis. FIG. 3 clearly describes an implementation method based on a controller, using a flowchart, in which control is differently treated between a plus and a minus as schematically described above. In the flowchart, a symbol “:=” represents allocation, and a calculation result of an expression on the left-hand side is allocated to a variable on the right-hand side.

First, in the first block B1 after the start, the control circuit 25 checks the number of luminance change steps S determined in the last control process. Here, ΔS represents the difference between the number of control steps S in the second to last control process and the number of control steps S in the last control process. A system state is preferably such that the last number of control steps ΔS is not zero but at least one. Accordingly, when surrounding luminance does not change, the illumination always changes in both directions by one step. The step is preferably small in illumination intensity to the extent that an observer does not recognize, or is unaware of such a change.

In the next block B2, the signals l representing illumination intensities are obtained. The sensors 18 detect them and transmit the signals l to the control circuit 19.

In the following block B3, for example, a method that subtracts a constant numerical value dIr from a counting variable dI is used to decrement (decrease) the counting variable. The numerical value dIr is preferably an integer equal to or more than zero. Alternatively, the counting variable may be multiplied by a factor less than one, for example, 0.98. In order to decrease the counting variable dIr at the time of passing through each loop, another method may be employed. The variable dI is used to detect the number of steps S and impose a limit at the time of darkening.

In the subsequent block B4, an illumination intensity L average value is calculated from the signals l. This can be done by calculating a current average value (running average).

In the block B5, a predetermined factor α is calculated by calculating the quotient resulting from dividing the last changed illumination intensity L by the last number of control steps ΔS. In the calculation, illumination intensity Lalt is illumination intensity at the end of the second to last measurement, whereas the illumination intensity L is illumination intensity obtained by the last measurement.

In the next block B6, it is determined whether or not the numerical value of the control difference |Lsoll−L| is larger than a limit value ε. In the case of NO, in the block B7, first, the flow pauses for, a predetermined time interval of, for example, 5 to 10 seconds, preferably 8 seconds, and then in order to obtain the illumination intensities l, the flow returns to B2 while skipping the interposed blocks.

On the other hand, in the block B6, when the control difference |Lsoll−L| exceeding the limit value ε is recorded, the flow branches to the block B8. In the block B8, the new number of steps S is calculated as a setting value from the sum of the previous number of steps, the control difference |Lsoll−L|, and the quotient calculated to obtain the predetermined factor α in the block B5.

In the next block B9, it is determined whether to require brightening or darkening. When the brightening is required, in the block B10, the brightening is immediately performed, i.e., by transmitting the relevant number of steps S to the drive circuit 24 through, for example, a DALI interface, the drive circuit increases the drive current i of the light sources 13, 14 as necessary. On the other hand, when the darkening is required, the counting variable dI is incremented by adding an amount determined by the number of steps ΔS thereto. This is represented by a function f(ΔS) in FIG. 3. The function f may be a linear function having a gradient of 1 (f=ΔS), a linear function having another gradient, or another explicit function such as a cubic parabolic function, an exponential function, or any equivalent function.

In the following block B12, it is checked whether or not the counting variable exceeds a limit value dIc. In the case of NO, a change limit is not reached, and in the block B10, the setting value S can be immediately outputted. However, when the change limit has been reached, in the block B13, a decrease in the setting value is limited. Note that the number of steps S for changing (decreasing) the luminance can be calculated from the last number of steps added with the control difference |Lsoll−L| divided by a factor ag larger than the factor calculated in the block B5. Accordingly, a decrease in the luminance step S is smaller than in the case of using the factor a calculated in the block B5 (in this case, (Lsoll−L) takes a minus value). Therefore, the control difference temporarily remaining is intentionally accepted, and the value S changed as described above is transmitted to the block B10. In the block B14, the flow pauses for a while (several seconds, e.g., 5 to 10 seconds, preferably 8 seconds), and then passes through the loop. The factor ag may be determined as a constant value. However, using another value, for example, using a value dI, the factor ag may be calculated. For example, the factor ag may be determined in proportion to dI. For example, ag=dI or in general, ag=f(dI) is applicable. In doing so, along with a continuous increase in dI, the factor ag further increases whenever the block B11 is subsequently repeated, and the decrease in the luminance may be further slowed down.

Delaying the luminance decrease is advantageous, and people are hardly or are not completely aware of a change in light incident direction due to switching from artificial light to daylight. On the other hand, when daylight darkens to quickly switch to artificial light, most of people are aware of switching a light incident direction without delay because the switching is visually expected.

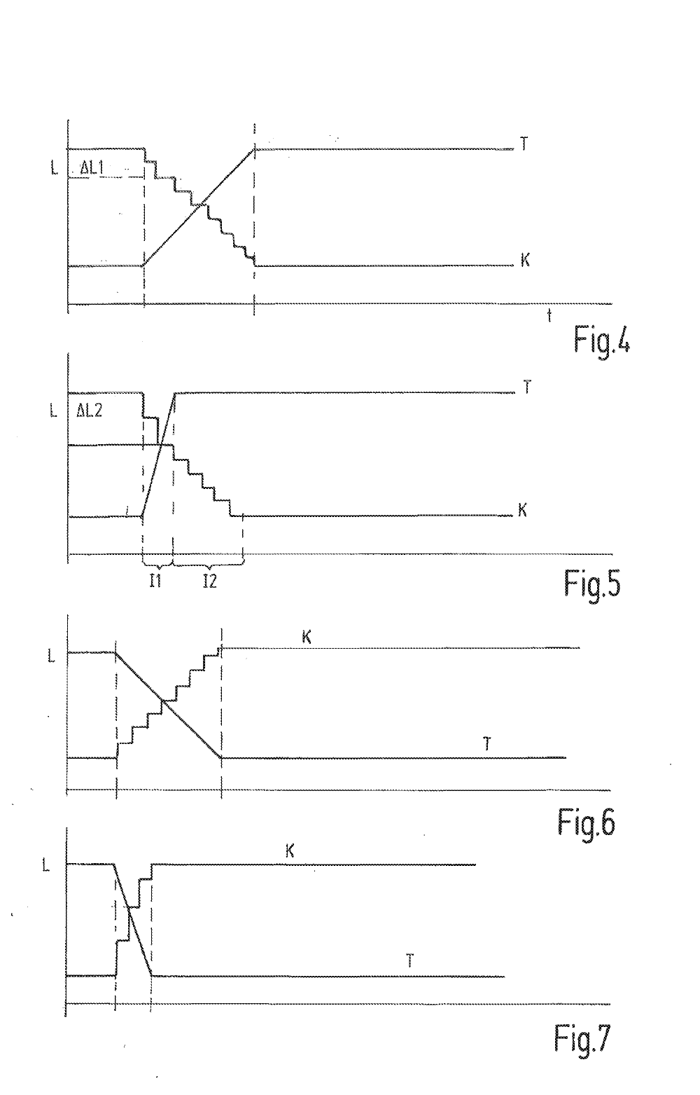

Control characteristics obtainable from the above are illustrated in FIGS. 4 and 5.

FIG. 4 illustrates a curve T indicating that daylight moderately increases. The artificial light K emitted from the light sources 13, 14 continuously passes from the block B1 to B6, B8, B9, B11, B12, B10, and B14, and is thereby decreased. The reason to skip the block B13 is because a decrease in the number of steps provided in the block B3 at least or excessively compensates for an increase in the number of steps in the block B11. A decrease ΔL1 caused by the illumination intensity of the light sources 13, 14 is not limited.

On the other hand, FIG. 5 illustrates a response to a change in the luminance of the artificial light K, which responds to a rapid increase in daylight T. The rapid increase in the daylight causes a decrease in the value of the factor a when calculating an increase amount in the block B5, and accordingly, in at least one or sometimes more luminance decrease steps, the luminance of the artificial light largely decreases during a time interval T1. However, this causes the counting variable dI to be largely incremented in the block B11 and immediately reach the change limit dIc, which is determined in the block B12. Accordingly, the illumination intensity of the light sources 13, 14 is maximally decreased by ΔL2 during the time interval T1. Accordingly, in the block B13, for example, the predetermined maximum value of the factor ag is used as the basis for the calculation of the number of steps S to limit a decrease in the setting value. As a result, during the subsequent interval I2, a step width ΔL is limited to decrease the luminance.

In contrast, FIGS. 6 and 7 illustrate that a decrease in daylight T is moderate (FIG. 6) and rapid (FIG. 7). In both cases, the illumination intensity of the artificial light quickly compensates for the decrease in the daylight without any delay. The degree of a step is not limited, and even when many large steps have been passed through, it is not limited.

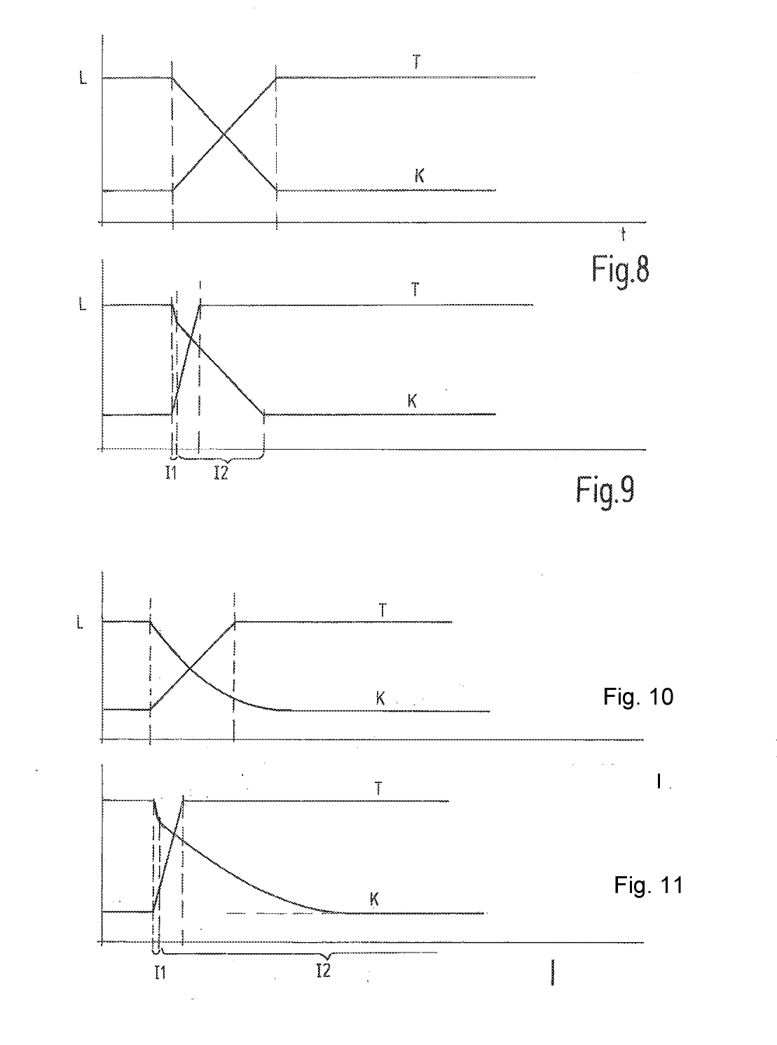

The subsequent graphs illustrate variations of the present invention. For example, each step and the resulting level difference may be small, and in such a case, pseudo-linear relationships in FIGS. 8 and 9 are obtained, to which the same way of thinking as above can be qualitatively applied. In addition, the drive circuit 24 may appropriately smooth a change in luminance.

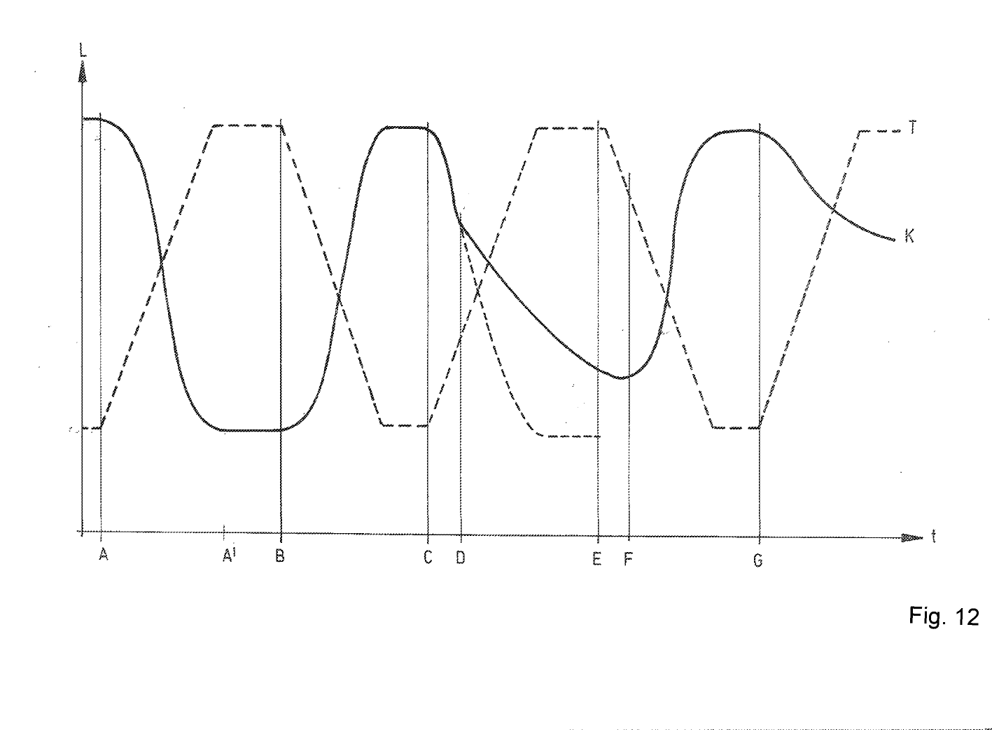

As illustrated in FIGS. 11 and 12, brightness may be adjusted in a short time or in a long time using a nonlinear function. In such a case, in accordance with any of a stepwise method and a continuous exponential method, a change in the illumination intensity of the light emitted from the light source 13, 14 is adapted to respond to daylight T whose intensity is increasing. As illustrated in FIG. 11, when the increase in the daylight is slowly provided (at a speed equal to or less than a limit speed), the artificial light illumination can be decreased without any delay. On the other hand, when the increase in the daylight is rapidly provided (at a speed equal to or more than the limit speed), the decrease in the artificial light is suppressed after the initial steep drop, and therefore decelerated. Accordingly, as with all of the previously described embodiment and variations, the total illumination intensity (the sum of the intensity of the artificial light and that of the daylight) can be increased to a necessary level or more in a short time. However, a user of course expects an increase in light intensity, and therefore does not feel uncomfortable with this.

What is common to the embodiment and variations in FIGS. 5, 9, and 12 is that although during the first time interval I1, the luminance of the light sources 13, 14 rapidly decreases, it is not necessary to adapt the illumination intensity of the light sources 13, 14 to the decrease. This is because the decrease is small as compared with the necessity to adapt the illumination intensity. The adaptation is rather performed in the time interval 12 subsequent to the time interval I1 by suppressing speed.

FIG. 13 illustrates a situation where cloudy weather and fair weather are alternately repeated. A dashed line T represents an ideal change in the daylight ratio of illumination intensity. FIG. 13 shows that during a time interval from the beginning to a time point A, a cloud is in front of the sun. The artificial light whose illumination intensity is represented by a curve K is set to a value of corresponding height.

During a time interval from the time point A to a time point B, the sun shows up, for example, a first time. In order to keep predetermined illumination intensity, the artificial light illumination is decreased as quickly as possible, for example, while following the curve K. In this case, the counting variable dI is incremented during a time interval from A to A′, i.e., during the decrease in the artificial light.

During a time interval from the time point B to a time point C, a cloud moves in front of the sun again (a second time). In order to keep the predetermined illumination intensity, the artificial light is rapidly increased.

During a time interval from the time point C to a time point D, the sun shows up again (e.g., for a second time). Until the time point D when the comparator block 21 (in the block B12) confirms that the counting variable dI exceeds the critical limit value, the intensity of the artificial light decreases as rapidly as possible. After that, the illumination moderately decreases. This is clarified by comparing the change in the artificial light illumination indicated by the curve K with a dashed line curve that is supposed to be drawn when a delay in illumination decrease is prevented and separates from K toward E. During a time interval from D to E, the further largely delayed decrease in the artificial light intensity is provided, and in this case, slightly excessive illumination (indicated by the gap between the curve K and the dashed line curve supposed to be “normal”) is involved.

During a time interval from E to F, the daylight decreases again (e.g., due to the third instance of the cloud moving in front of the sun). However, since the predetermined illumination intensity is still exceeded, the intensity of the artificial light is continuously decreased.

During a time interval from F to G, at first, the predetermined illumination intensity is not reached yet. In order to keep the predetermined illumination intensity, the artificial light is increased as rapidly as possible. The counting variable dI is incremented.

At the time point G, the sun again shows up. The intensity of the artificial light is moderately decreased. This is because in the block B3, dI is decremented at the time of passing through the step B3 in any program loop; however, the previous darkening interval due to cloud is short, and therefore dI is continuously equal to or more than the limit value dIc. Of course, the factor ag at the time point G is small as compared with that at the time point F because dI is decremented between F and G.

A concept as disclosed herein is to provide the sensor-controlled illumination apparatus (13, 14) whose response to light is basically made at a small time constant. This is applicable both when brightening illumination and when darkening illumination. However, when darkening the illumination, the speed of the darkening is limited by a process. That is, when a decrease in luminance per unit time exceeds a limit value, or multiple darkening processes are performed in a short time, for example, successively performed in minutes, the limit is imposed. The above-described method makes it easy to successfully adapt illumination to given necessary conditions on one hand, and on the other hand, allows people in an illuminated area to feel less uncomfortable with the sequential adjustment of illumination, or in an ideal case, to be unaware of the adjustment.

The previous detailed description has been provided for the purposes of illustration and description. Thus, although there have been described particular embodiments of a new and useful invention, it is not intended that such references be construed as limitations upon the scope of this invention except as set forth in the following claims.

1-15. (canceled)

16. An apparatus for controlling illumination in a space, the apparatus comprising:
at least one sensor configured to detect illumination intensity at a selected location in the space;
a drive circuit configured to supply drive current to one or more light sources in the space; and
a control circuit having an input linked to the at least one sensor and an output linked to the drive circuit, the control circuit configured to control the drive circuit for increasing or decreasing the drive current, based at least on the illumination intensity detected by the sensor,
wherein when a previous decrease does not exceed a limit value, the drive circuit is controlled to decrease the drive current at a first rate, and
wherein when the previous decrease reaches or exceeds the limit value, the drive circuit is controlled to decrease the drive current at a second rate lower than the first rate.

17. The apparatus of claim 16, wherein the control circuit is configured to detect an accumulated decrease in the illumination intensity via a counting variable, wherein the counting variable is adjusted in relation to a provided decrease in the illumination intensity.

18. The apparatus of claim 17, wherein
the accumulated decrease in the illumination intensity detected via the counting variable is continuously accumulated by decreasing the counting variable in a stepwise manner and with a predetermined timing.

19. The apparatus of claim 16, wherein
the drive circuit is controlled so as to decrease the drive current in a stepwise manner.

20. The apparatus of claim 16, wherein
the drive circuit is controlled so as to smoothly decrease the drive current.

21. The apparatus of claim 20, wherein
a change in speed for the luminance is proportional to a difference between a desired illumination intensity and the illumination intensity detected by the sensor.

22. The apparatus of claim 16, wherein
the drive circuit is controlled to, independently of an illumination intensity amount to be changed, increase the drive current without reference to a limit value for increase in luminance per unit time.

23. The apparatus of claim 16, wherein
the control circuit is configured, when the illumination intensity is too high, to temporarily allow a control difference that is large as compared with when the illumination intensity is too low.

24. The apparatus of claim 16, wherein
the drive circuit and the control circuit are separate devices mutually connected through control wiring.

25. A method for controlling light in a space illuminated via at least one electrical light source, the method comprising:
detecting illumination intensity at a selected location in the space via at least one sensor;
determining a drive current corresponding to the detected illumination intensity;
increasing or decreasing the drive current based at least on the detected illumination intensity,
wherein when an accumulated decrease in the illumination intensity during a previous time interval does not exceed a limit value, the drive current is decreased at a first high rate, and
wherein when the accumulated decrease in the illumination intensity reaches or exceeds the limit value, the drive current is decreased at a second and lower rate.

26. The method according to claim 25, wherein
the drive current is decreased in a stepwise manner.

27. The method according to claim 26, wherein
an amount of a step is determined in proportion to a difference between desired illumination intensity and the illumination intensity detected by the sensor.

28. The method according to claim 25, wherein
the drive current is smoothly decreased.

29. The method according to claim 25, wherein
when the illumination intensity is too high, a control difference is temporarily allowed that is large as compared with when the illumination intensity is too low.

30. The method according to claim 25, wherein
the drive current is increased at a predetermined rate independently of an illumination intensity amount to be changed.

31. The method according to claim 25, wherein
an accumulated decrease in the illumination intensity is detected via a counting variable, wherein the counting variable is adjusted in relation to a provided decrease in the illumination intensity.

32. The method according to claim 31, wherein
the accumulated decrease in the illumination intensity detected via the counting variable is continuously accumulated by decreasing the counting variable in a stepwise manner and with a predetermined timing.
